(19) United States
(12) Patent Application Publication
(10) Pub. No.: US 2022/0278634 A1
(43) Pub. Date: Sep. 1, 2022

(54) METHOD FOR CONTROLLING BUS CURRENT OF BRUSHLESS DC ELECTRIC MOTOR, AND CONTROLLER

(71) Applicant: Robert Bosch GmbH, Stuttgart (DE)

(72) Inventors: Zheng Wang, Suzhou (CN); Jun Wang, Suzhou (CN); Yang Yang, Suzhou (CN); Hao Zhao, Suzhou (CN); Wei Tang, Suzhou (CN); Zhimao Zhang, Suzhou (CN)

(21) Appl. No.: 17/679,263

(22) Filed: Feb. 24, 2022

(30) Foreign Application Priority Data
Feb. 24, 2021 (CN) 202110205529.7

(51) Int. Cl. H02P 6/28; H02P 6/08; H02K 21/02; H02K 11/25

(52) U.S. Cl. CPC H02P 6/28; H02P 6/085; H02K 21/02; H02K 11/25; H02P 27/08

(57) ABSTRACT

The present invention relates to a method for controlling a bus current of a brushless DC electric motor, comprising: obtaining currents of three phases of a stator; converting the currents of the three phases to a direct-axis current and a quadrature-axis current; based on the direct-axis current, the quadrature-axis current and an efficiency ratio of the electric motor, determining a bus current of the electric motor, wherein the efficiency ratio corresponds to a present operating condition of the electric motor. The method does not need to introduce shunt resistors on the bus, and also enables closed-loop control of bus current.

### BACKGROUND OF THE INVENTION

The present invention relates to the field of DC electric motor control, in particular to a method for controlling a bus current of a brushless DC electric motor.

To measure or control a bus current of a DC electric motor, a shunt resistor and an analogue-to-digital converter are often used in the prior art for measurement. However, using a shunt resistor will increase the cost of controlling the DC electric motor.

One mature technology for controlling electric motors (such as brushless DC electric motors) is field-oriented control (FOC) technology. The basic idea of this technology is to use Clarke-Park transforms in a control loop designed for generating currents in three windings of a stator; these can transform three-phase current quantities I_{U}, I_{V} and I_{W} (i.e., a triple of electric motor stator phase currents) to two-phase quantities: direct-axis current Id and quadrature-axis current Iq. In this way, an electric equation of an AC electric motor can become the same as an electric equation of a DC electric motor.

### SUMMARY OF THE INVENTION

One aspect of the present invention is enabling the control of brushless DC electric motor bus current.

For this purpose, the present invention provides a method for controlling a bus current of a brushless DC electric motor, comprising: obtaining currents of three phases U, V, W of a stator; converting the currents of the three phases to a direct-axis current and a quadrature-axis current; based on the direct-axis current, the quadrature-axis current and an efficiency ratio of the electric motor, determining a bus current of the electric motor, wherein the efficiency ratio corresponds to a present operating condition of the electric motor.

Optionally, the method further comprises determining the following operating conditions of the electric motor: an operating temperature of the electric motor; a bus voltage of the electric motor; an angular velocity of the electric motor; and a torque of the electric motor.

Optionally, the efficiency ratio of the electric motor is obtained by querying an electric motor efficiency table, wherein the electric motor efficiency table records a correspondence between electric motor efficiency and electric motor operating conditions.

Another aspect of the present invention is providing a controller for a brushless DC electric motor, comprising: a current conversion unit, configured to determine a direct-axis current and a quadrature-axis current based on currents of three phases of an electric motor stator; and a bus current determining unit, configured to determine a bus current of the electric motor based on the direct-axis current, the quadrature-axis current and an efficiency ratio of the electric motor, wherein the efficiency ratio corresponds to a present operating condition of the electric motor.

Optionally, the bus current determining unit is configured to query an electric motor efficiency table to obtain the efficiency ratio, wherein the electric motor efficiency table records a correspondence between electric motor efficiency and operating conditions.

Optionally, the current conversion unit and bus current determining unit are integrated on a chip.

Optionally, the system further comprises a bridge driver and multiple switch control assemblies, the bridge driver and the multiple switch control assemblies being configured to generate three-phase currents supplied to the electric motor stator based on a pulse width modulation signal; and supply three-phase currents measured via shunt resistors to the current conversion unit.

The bus current control method provided by the present invention can determine the bus current of the brushless DC electric motor according to the operating conditions and efficiency ratio of the electric motor, without the need to introduce shunt resistors on the bus; this reduces costs, while also enabling closed-loop control or adjustment of bus current. The present invention also provides a controller for a brushless DC electric motor; the controller not only avoids the use of a shunt resistor, but also realizes a microcontroller unit with a high degree of integration, which integrates functions such as current conversion, bus current determination and PWM signal supply.

### BRIEF DESCRIPTION OF THE DRAWINGS

FIG. 1 shows a schematic flow chart of a method for controlling a bus current of a brushless DC electric motor in an embodiment of the present invention.

FIG. 2 shows a modular structural diagram of a controller for a brushless DC electric motor in an embodiment of the present invention.

FIG. 3 shows a modular structural diagram of a field-oriented control system.

FIG. 4 shows multiple switch control assemblies according to an embodiment of the present invention.

### DETAILED DESCRIPTION

Specific details are presented in the following description, in order to provide a thorough understanding of the present invention. However, those skilled in the art will know clearly that embodiments of the present invention could be implemented even without these specific details. In the present invention, specific numerical references are possible, e.g., “first element”, “second apparatus”, etc. However, specific numerical references should be understood to mean not that the literal order thereof needs to be adhered to, but that the “first element” is different from the “second element”.

The specific details presented in the present invention are merely demonstrative and can change while still falling within the spirit and scope of the present invention. The term “coupled” is defined to mean directly connected to a component or indirectly connected to a component via another component. In addition, the terms “about” and “substantially” used herein for any values or ranges indicate a suitably allowed deviation and will not affect the implementation result of the present invention.

Preferred embodiments suitable for implementing the method, system and apparatus of the present invention are described below by referring to the figures. Although each embodiment is described for a single combination of elements, it should be understood that the present invention includes all possible combinations of the elements disclosed. Thus, if one embodiment includes elements A, B and C, and a second embodiment includes elements B and D, then the present invention should also be regarded as including the other remaining combinations of A, B, C or D, even if these are not disclosed explicitly.

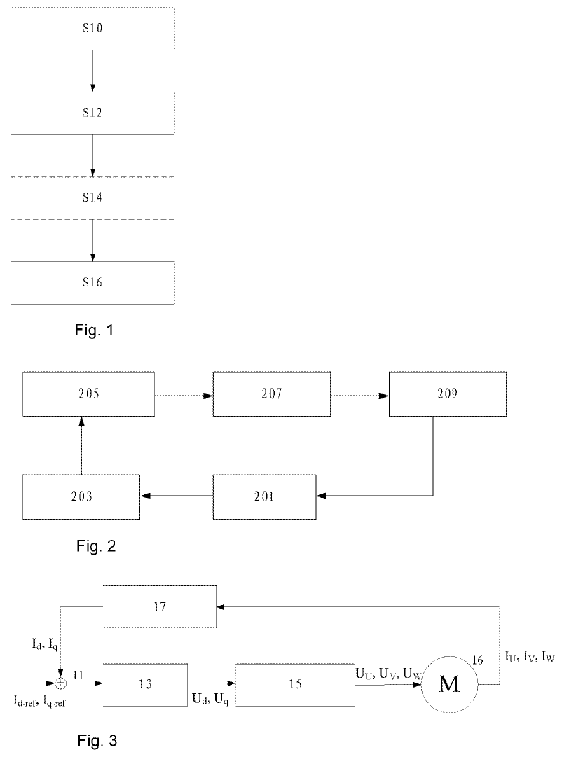

As shown in FIG. 1, an embodiment of the present invention provides a method for controlling a bus current of a brushless DC electric motor, comprising steps S10-S12-S14-S16, wherein step S14 is an optional step.

Step S10, obtaining currents of three phases U, V, W of a stator.

In this step, as an example, currents I_{U}, I_{V}, I_{W} of the three phases U, V, W can be measured from the stator of the DC electric motor by means of three independent sensors or shunt resistors.

Step S12, converting the currents of the three phases to a direct-axis current and a quadrature-axis current.

In this step, Clarke-Park transforms in FOC technology are used to transform the current quantities I_{U}, I_{V} and I_{W} of the three phases of the stator to two-phase quantities: a direct-axis current I_{d} and a quadrature-axis current I_{q}. A direct axis d of a reference system fixed relative to a rotor points towards the north pole N of the rotor, and a quadrature axis q is rotated by +90° relative to the direct axis d. The direct axis d and quadrature axis q represent a rotating reference system of the electric motor.

FIG. 3 shows a field-oriented control (FOC) system. Specifically, the control system comprises an adder 11 at an input end thereof. The adder 11 represents a comparison node of closed-loop control, and at its input node receives the direct-axis current I_{d} and quadrature-axis current I_{q} of the electric motor as one input, while also receiving reference values I_{d-ref}, I_{q-ref} for direct-axis current and quadrature-axis current as another input. The direct-axis current and quadrature-axis current may be obtained directly by a Clarke-Park transform unit 17 performing Clarke-Park transforms on stator phase currents. At its output end, the adder 11 may provide the difference between the direct-axis current and the direct-axis current reference value as an adjustment quantity. In some embodiments, the FOC control system also has an angular velocity reference value ω* and an angular velocity measurement value w of the electric motor as inputs of the adder 11.

In the FOC system, a current controller 13 may subject the adjustment quantity outputted by the adder 11 to operations such as proportional-integral-derivative (PID) operations. In some embodiments, the difference between the rotor angular velocity reference value ω* and the angular velocity ω measurement value may also be sent to the controller 13. The current controller 13 may subject the current adjustment quantity or angular velocity adjustment quantity from the adder 11 to at least one proportional operation and one integral operation, generating a direct-axis voltage U_{d} and a quadrature-axis voltage U_{q} to be provided to an inverse Clarke-Park transform unit 15.

By subjecting the direct-axis voltage U_{d} and quadrature-axis voltage U_{q} to inverse Clarke-Park transforms, the inverse Clarke-Park transform unit 15 outputs three phase voltages U_{U}, U_{V}, U_{W} for stator windings of an electric motor 16. At the same time, measurement values of corresponding currents I_{U}, I_{V}, I_{W} in the three stator windings may be obtained by measurement from the electric motor 16, and provided to the Clarke-Park transform unit 17, which performs direct Clarke-Park transforms to obtain the direct-axis current I_{d} and quadrature-axis current I_{q}, and the direct-axis current I_{d} and quadrature-axis current I_{q} are then inputted to the adder 11 together with corresponding current reference values, thereby forming a closed loop of control.

As an optional step, step S14 may be used to determine the present operating conditions of the electric motor. The operating conditions may indicate parameters of the environment and of the electric motor itself when it is operating; as an example, the operating conditions of the electric motor comprise the electric motor's operating temperature, bus voltage, angular velocity and outputted torque, etc. Since the electric motor's operating conditions are continuously changing, a bus current used to control the electric motor preferably also changes correspondingly, in order to provide a torque output that meets expectations, while reducing the phenomenon of tremor that might occur in the electric motor (arising due to the effects of high static friction and mechanical backlash). In certain specific application scenarios, for example, for a DC brushless electric motor in an air conditioning compressor, it is also possible to select compressor pressure, refrigerant type, etc. as electric motor operating condition parameters.

Step S16, determining a bus current based on the direct-axis current, quadrature-axis current and an efficiency ratio of the electric motor.

In this step, the bus current of the electric motor can be determined according to the direct-axis current I_{d} and quadrature-axis current I_{q} and the efficiency ratio of the electric motor; thus, there is no longer any need to attach a shunt resistor to the bus. The efficiency ratio of the electric motor may correspond to the present operating conditions of the electric motor. In some embodiments, at least some of the present operating condition parameters may be obtained directly from a reading table of the electric motor. Alternatively, the present operating conditions may be obtained via an external sensor attached to the electric motor. In other embodiments, some of the present operating condition parameters of the electric motor may be predicted based on an average value of operating condition indices of the electric motor within the preceding time period.

In some embodiments of the present invention, the following formula is used to calculate a DC bus current IDC:

IDC=k(Ud*Id+Uq*Iq)/(UDC*η) (formula 1)

wherein Ud is the direct-axis voltage, Uq is the quadrature-axis voltage, I_{d} is the direct-axis current, I_{q} is the quadrature-axis current, η is the efficiency ratio of the electric motor, k is an adjustment factor, and UDC is the bus voltage of the electric motor (or the rated voltage may be used). The efficiency ratio 11 of the electric motor may be obtained by querying an electric motor efficiency table which records the correspondence between the electric motor efficiency and the electric motor operating conditions. The direct-axis current and quadrature-axis current may be obtained in step S12, specifically from the Clarke-Park transform unit 17. The direct-axis voltage Ud and quadrature-axis voltage Uq may be obtained directly by a PID control model used by the current controller 13 subjecting the direct-axis current and quadrature-axis current to calculation. The adjustment factor k may perform fine adjustment corresponding to different grades (e.g., rated voltages) or models of DC electric motor. As an example, for a DC brushless electric motor, an adjustment factor k of roughly ⅔ or about 0.6-0.7 may be used.

To obtain the electric motor efficiency table, different grades of DC brushless electric motors may be separately tested, recording angular velocity, output torque and efficiency curves thereof as well as other appropriate operating condition parameters (determined according to circumstances). As an example, when the operating temperature of the electric motor is 80 degrees, the bus voltage is 48 V; taking the rotation speed (in units of rpm) as the horizontal coordinate and torque as the vertical coordinate, the efficiency of the electric motor (the ratio of electric motor output power to input power) at different rotation speeds and different torques is recorded. As another example, for a DC brushless electric motor with a rated power of 40 kW and a rated torque of 2300 r/min, the efficiency thereof at different temperatures and different torques is measured. In this way, an electric motor efficiency table can be formed. In some embodiments, for a DC brushless electric motor used in an air conditioning compressor, in order to determine the power of the electric motor in different operating conditions, a model may also be constructed according to multiple sets of obtained test data, and the model may be corrected with new test data. Multiple different electric motor efficiency models may be obtained for different combinations of temperature and compressor low-pressure pressures.

Based on the present operating conditions of the electric motor, the efficiency ratio corresponding to the present operating conditions of the electric motor may be queried from the electric motor efficiency table or calculated by the efficiency model. The bus current IDC may then be calculated directly according to formula 1 above, and it is thus possible not only to avoid using an expensive shunt resistor but also, when necessary, to subject the electric motor bus current to closed-loop control or adjustment based on the IDC.

The mechanism of the present invention may be implemented and distributed as a software program on an information carrying medium readable by an electronic processor (e.g., a non-transitory computer-readable and/or -recordable/writable information carrying medium readable by a processing system). According to some embodiments of the present invention, a machine-readable storage medium is provided, on which may be stored a set of computer-executable instructions which, when executed by a processor (including a microprocessor and a kernel thereof, or an MCU), can implement the method described above for controlling a bus current of a brushless DC electric motor.

Another embodiment of the present invention provides a controller for a brushless DC electric motor, generally comprising a current conversion unit 203 and a bus current determining unit 205. The current conversion unit 203 is configured to determine the direct-axis current I_{d} and quadrature-axis current I_{q} based on the currents I_{U}, I_{V}, I_{W} of the three phases of the electric motor stator. The bus current determining unit 205 receives the direct-axis current and quadrature-axis current as inputs from the current conversion unit 203 and determines the bus current of the electric motor based on the direct-axis current, the quadrature-axis current and the electric motor efficiency ratio. The efficiency ratio corresponds to the present operating conditions of the electric motor. The operating conditions of the electric motor generally comprise operating temperature, DC bus voltage, electric motor angular velocity and output torque.

Based on Clarke-Park transforms, the current conversion unit 203 can convert the currents I_{U}, I_{V}, I_{W} of the three phases to the direct-axis current and quadrature-axis current. The currents of the three phases may be measured via shunt resistors connected in parallel with the three windings of the stator but may also be measured by other current sensors. The shunt resistors or current sensors of another type, together with a pathway for transmitting sensor signals, may be formed as a measurement unit 201 which is part of the controller.

The bus current determining unit 205 queries the electric motor efficiency table to obtain the efficiency ratio corresponding to the present operating conditions. The electric motor efficiency table records the correspondence between the electric motor efficiency and the electric motor operating conditions. The bus current determining unit 205 then calculates the bus current of the electric motor according to formula 1 above. Thus, a shunt resistor for measuring bus current need not be attached to the bus.

In some embodiments, the current conversion unit 203 and bus current determining unit 205 may be formed as a microcontroller unit (MCU) and may be integrated on a chip. In other embodiments, the abovementioned controller may comprise other units or components, e.g., a bridge driver 207, a switch control assembly 209 and the measurement unit 201, as shown in FIG. 2. The bridge driver 207 and switch control assembly 209 act together, generating three-phase currents supplied to the electric motor stator based on a pulse width modulation signal, and at the same time supplying to the current conversion unit 203 the three-phase currents measured via the shunt resistors (connected in parallel with the three windings), thereby forming a closed loop of control.

As a more specific example, the current conversion unit 203 and bus current determining unit 205 form an MCU, and in addition to performing the functions of current conversion and bus current determination, may also supply a 3.3 V pulse width modulation (PWM) signal; the PWM signal may be supplied to the bridge driver 207, and the bridge driver 207 amplifies the PWM signal to 10 V. The switch control assembly 209 then subjects the amplified signal to switch control, thereby generating the three-phase currents supplied to the electric motor stator. Such an MCU having a high degree of integration may be implemented on a chip; this facilitates direct use in various application scenarios and can also reduce the cost of implementation.

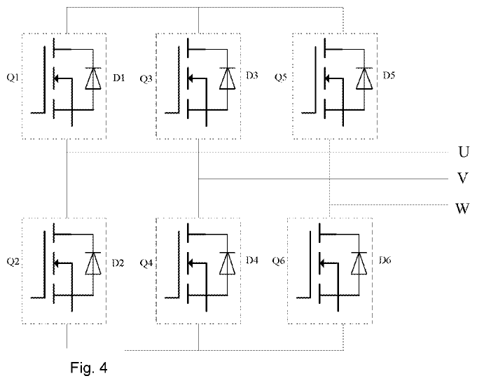

In some embodiments, the switch control assembly 209 comprises multiple switch (control) assemblies, wherein each switch assembly may be formed of a field effect transistor and a diode connected in parallel. As shown in FIG. 4, a first switch assembly is formed of a field effect transistor Q1 and a diode D1 connected in parallel, and a second switch assembly is formed of a field effect transistor Q2 and a diode D2 connected in parallel; the phase current I_{U} may be supplied to a connection terminal between these two switch assemblies. A third switch assembly is formed of a field effect transistor Q3 and a diode D3 connected in parallel, and a fourth switch assembly is formed of a field effect transistor Q4 and a diode D4 connected in parallel; the phase current I_{V} may be supplied to a connection terminal between these two switch assemblies. A fifth switch assembly is formed of a field effect transistor Q5 and a diode D5 connected in parallel, and a sixth switch assembly is formed of a field effect transistor Q6 and a diode D6 connected in parallel; the phase current I_{W} may be supplied to a connection terminal between these two switch assemblies. The bridge driver 207 may further supply a switch-on signal for each switch assembly, so that the switch control assembly 209 outputs three-phase currents meeting the needs of the electric motor.

At the same time as supplying the phase current output, the switch control assembly 209 may also feedback the three-phase currents of the stator to the measurement unit 201; the measurement unit 201 measures the phase currents I_{U}, I_{V}, I_{W}, and supplies them to the current conversion unit 203, so that the current conversion unit 203 can perform the Clarke-Park transforms.

Some embodiments of the present invention provide a brushless DC electric motor for driving an air conditioning compressor, which motor may comprise the controller as described above. Other embodiments of the present invention provide an air conditioning compressor, configured to be driven by the brushless DC electric motor mentioned above. In accordance with the general idea of the present invention, such a brushless DC electric motor and such an air conditioning compressor both fall within the scope of protection of the present invention.

Those skilled in the art will understand that the various illustrative logic blocks, modules, circuits and algorithm steps described in conjunction with the aspects disclosed herein may be implemented as electronic hardware, computer software or a combination of the two. In order to demonstrate the interchangeability of hardware and software, various illustrative components, blocks, modules, circuits and steps have been described above in a general fashion according to their functionality. Whether such functionality is implemented as hardware or as software will depend on the specific application and the design restrictions applied to the overall system. Those skilled in the art could implement the described functionality according to the manner of change for particular, specific applications, but such an implementation decision should not be understood as causing deviation from the scope of the present invention.

The description above is merely directed at preferred embodiments of the present invention, without restricting the scope of protection thereof. Those skilled in the art could make various variant designs without departing from the idea of the present invention and the attached claims.

1. A method for controlling a bus current of a brushless DC electric motor, comprising:
a) obtaining, at least one sensor, currents of three phases U, V, W of a stator;
b) converting, via field-oriented control system, the currents of the three phases to a direct-axis current Id and a quadrature-axis current Iq;
c) based on the direct-axis current, the quadrature-axis current and an efficiency ratio of the electric motor, determining a bus current of the electric motor, wherein the efficiency ratio corresponds to a present operating condition of the electric motor.

2. A control method according to claim 1, wherein step c) comprises calculating the bus current from the following formula:
IDC=k(Ud*Id+Uq*Iq)/(UDC*η),
where IDC is the bus current, Ud is a direct-axis voltage, Uq is a quadrature-axis voltage, η is the efficiency ratio of the electric motor, UDC is a bus voltage of the electric motor, and k is an adjustment factor.

3. The control method according to claim 1, further comprising:
determining the following operating conditions of the electric motor:
an operating temperature of the electric motor;
a bus voltage of the electric motor;
an angular velocity of the electric motor; and
a torque of the electric motor.

4. The control method according to claim 3, wherein the efficiency ratio of the electric motor is obtained by querying an electric motor efficiency table, wherein the electric motor efficiency table records a correspondence between electric motor efficiency and electric motor operating conditions.

5. The control method according to claim 1, wherein step a) comprises:
using three shunt resistors to measure the currents of the three phases U, V, W of the stator respectively.

6. A controller for a brushless DC electric motor, comprising:
a current conversion unit, configured to determine a direct-axis current and a quadrature-axis current based on currents of three phases U, V, W of an electric motor stator;
a bus current determining unit, configured to determine a bus current of the electric motor based on the direct-axis current, the quadrature-axis current and an efficiency ratio of the electric motor, wherein the efficiency ratio corresponds to a present operating condition of the electric motor.

7. The controller according to claim 6, wherein the bus current determining unit is configured to:
query an electric motor efficiency table to obtain the efficiency ratio, wherein the electric motor efficiency table records a correspondence between electric motor efficiency and operating conditions.

8. The controller according to claim 6, wherein the current conversion unit is configured to convert the currents of the three phases to the direct-axis current and the quadrature-axis current based on Clarke-Park transforms.

9. The controller according to claim 6, wherein the controller further comprises an operating condition determining unit, configured to determine the following operating conditions of the electric motor:
an operating temperature of the electric motor;
a bus voltage of the electric motor;
an angular velocity of the electric motor; and
a torque of the electric motor.

10. The controller according to claim 6, wherein the controller further comprises a bridge driver and multiple switch control assemblies, the bridge driver and the multiple switch control assemblies being configured to:
generate three-phase currents supplied to the electric motor stator based on a pulse width modulation signal; and
supply three-phase currents measured via shunt resistors to the current conversion unit.

11. The controller according to claim 10, wherein the bridge driver is further configured to supply a switch-on signal for the multiple switch control assemblies.

12. A non-transitory, computer-readable storage medium, having stored thereon a set of computer-executable instructions which, when executed by a computer cause the computer to
a) obtain, at least one sensor, currents of three phases U, V, W of a stator;
b) convert the currents of the three phases to a direct-axis current Id and a quadrature-axis current Iq;
c) based on the direct-axis current, the quadrature-axis current and an efficiency ratio of the electric motor, determining a bus current of the electric motor, wherein the efficiency ratio corresponds to a present operating condition of the electric motor.

13. A brushless DC electric motor for driving an air conditioning compressor, comprising a controller having
a current conversion unit, configured to determine a direct-axis current and a quadrature-axis current based on currents of three phases U, V, W of an electric motor stator;
a bus current determining unit, configured to determine a bus current of the electric motor based on the direct-axis current, the quadrature-axis current and an efficiency ratio of the electric motor, wherein the efficiency ratio corresponds to a present operating condition of the electric motor.

14. An air conditioning compressor, configured to be driven by a brushless DC electric motor comprising a controller having
a current conversion unit, configured to determine a direct-axis current and a quadrature-axis current based on currents of three phases U, V, W of an electric motor stator;
a bus current determining unit, configured to determine a bus current of the electric motor based on the direct-axis current, the quadrature-axis current and an efficiency ratio of the electric motor, wherein the efficiency ratio corresponds to a present operating condition of the electric motor.
